(19) United States
(12) Patent Application Publication
(10) Pub. No.: US 2011/0296998 A1
(43) Pub. Date: Dec. 8, 2011

(54) PARTICULATE SCAVENGER MEDIUM CANISTER

(76) Inventor: Alan B. Morison, Grande Prairie (CA)

(21) Appl. No.: 13/156,263

(22) Filed: Jun. 8, 2011

(30) Foreign Application Priority Data
Jun. 8, 2010 (CA) 2706495

(51) Int. Cl. B01D 53/06

(52) U.S. Cl. 96/147; 96/150

(57) ABSTRACT

A particulate scavenger medium canister with a tubular body having a defining peripheral sidewall with an interior surface defining an internal flow passage and an exterior surface, a bottom, and a top. The tubular body has a flow passage that is in fluid communication with a gas inlet and a gas outlet. Scavenger medium in the form of a plurality of loose discrete particles are positioned in the flow passage. Gas entering the gas inlet must flow through the scavenger medium positioned in the internal flow passage in order to reach the gas outlet. A gas permeable solids barrier is positioned across the bottom of the tubular body permitting a flow of gas through the gas permeable solids barrier, while preventing the loss of the discrete particles of the scavenger medium from the bottom of the tubular body.

### FIELD

There is described a canister that is used to hold particulate scavenger medium, such as scavenger medium that is used to remove hydrogen sulphide gas.

### BACKGROUND

Particulate scavenger medium, such as SULFATREAT (Trademark) or SULPHABIND (Trademark) is used in the oil and gas industry to remove hydrogen sulphide from natural gas. The particulate scavenger medium comes in bags, which are poured into treatment vessels. The treatment vessels have gas inlets and gas outlets arranged, such that natural gas entering the inlet must migrate through the particulate scavenger to reach the outlet. During the process of such migration, hydrogen sulphide is removed from the natural gas. When the particulate scavenger medium is saturated with hydrogen sulphide, it is removed from the treatment vessel and regenerated. Removal from the treatment vessel currently involves the use of a vacuum truck to vacuum up the particulate scavenger medium. The treatment vessel is then cleaned using a pressure washer to remove residue, and refilled with particulate scavenger medium. What is required as a more convenient manner of handling the particulate scavenger medium.

### SUMMARY

There is provided a particulate scavenger medium canister with a tubular body having a defining peripheral sidewall with an interior surface defining an internal flow passage and an exterior surface, a bottom, and a top. The tubular body has a flow passage that is in fluid communication with a gas inlet and a gas outlet. Scavenger medium in the form of a plurality of loose discrete particles are positioned in the flow passage. Gas entering the gas inlet must flow through the scavenger medium positioned in the internal flow passage in order to reach the gas outlet. A gas permeable solids barrier is positioned across the bottom of the tubular body permitting a flow of gas through the gas permeable solids barrier, while preventing the loss of the discrete particles of the scavenger medium from the bottom of the tubular body.

The use of the particulate scavenger medium canister, as described above, entirely changes the procedure for replacing the scavenger medium in a gas treatment vessel. All that is required is a lifting apparatus to lift the canister out of and lower a replacement canister into the gas treatment vessel. A vacuum truck is no longer required to vacuum up the discrete particles. A pressure washer is no longer required to clean residues from the interior of the gas treatment vessel.

It is envisaged that the particulate scavenger medium canister, described above, will be positioned in a gas scrubbing unit which includes a gas treatment vessel having a defining sidewall with an interior surface defining an interior cavity and an exterior surface, a top and a bottom, a gas inlet positioned on or near the bottom of the vessel, a gas outlet positioned on or near the top of the vessel. In order to accommodate the particulate scavenger medium canister, the vessel will have a canister seat positioned within the interior cavity and a canister insertion and removal opening closed by a closure. An annular seal must be positioned between the interior surface of the vessel and the exterior surface of the tubular body when the tubular body is positioned on the canister seat to prevent gas from migrating between the interior surface of the vessel and the exterior surface of the tubular body. With the annular seal in place, the only path to the gas outlet of the vessel is through the internal flow passage of the tubular body of the particular scavenger medium canister, where the gas will react with the particulate scavenger medium.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a particulate scavenger medium canister.

FIG. 2 is a side elevation view of the particulate scavenger medium canister shown in FIG. 1, partially in section and showing gas flow.

FIG. 3 is a top plan view of the particulate scavenger medium canister shown in FIG. 1.

FIG. 4 is a bottom plan view of the particulate scavenger medium canister shown in FIG. 1.

FIG. 5 is a partially exploded side elevation view of the particulate scavenger medium canister shown in FIG. 1 with a removable transport closure.

FIG. 6 is a side elevation view of two stacked particulate scavenger medium canisters.

FIG. 7 is a side elevation view, partially in section, of gas scrubber units containing particulate scavenger medium canisters.

### DETAILED DESCRIPTION

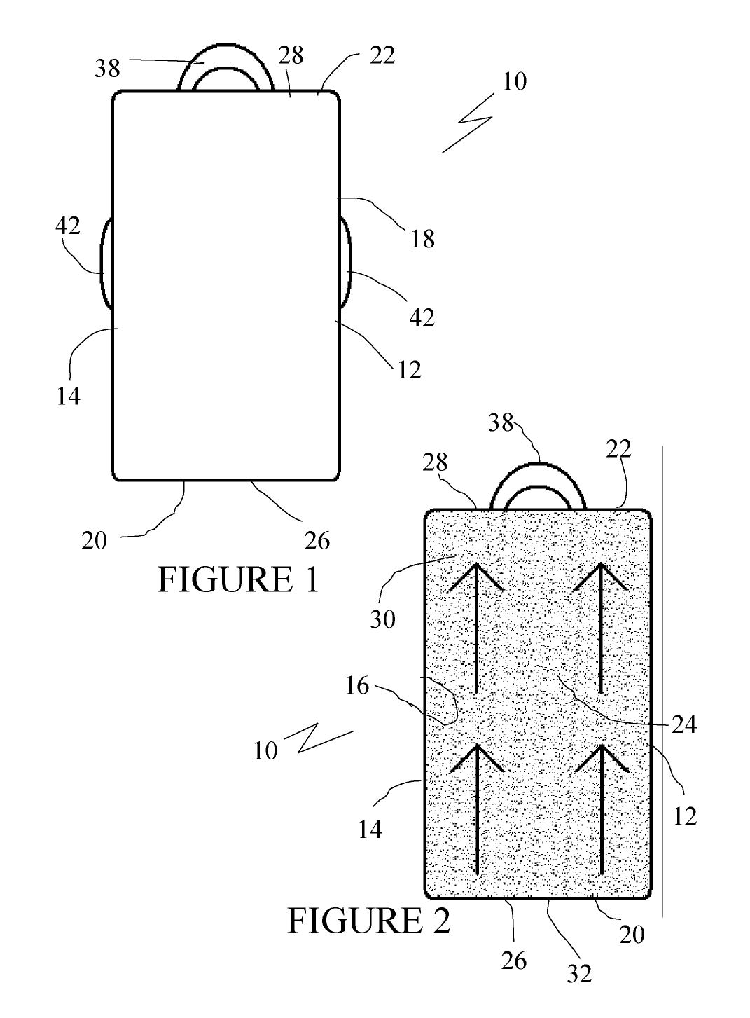

A particulate scavenger medium canister generally identified by reference numeral 10, will now be described with reference to FIGS. 1 through 7.

### Structure and Relationship of Parts:

Referring to FIG. 1 and FIG. 2, a particulate scavenger medium canister 10 includes a tubular body 12 that has a defining peripheral sidewall 14 with an interior surface 16, an exterior surface 18, a bottom 20 and a top 22. Interior surface 16 defines an internal flow passage 24 which has a gas inlet 26 and a gas outlet 28. Scavenger media 30, in the form of a plurality of loose discrete particles, is positioned in flow passage 24 such that gas entering gas inlet 26 must flow through the scavenger media 30 in order to reach gas outlet 28. Canister 10 is preferably made of stainless steel as it will not corrode, is easy to clean, is light for handling and a thinner gauge can be used during manufacturing, however it will be understood that other types of metal may be used in the manufacturing of canister 10.

Referring to FIG. 4, a gas permeable solids barrier 32 is positioned across bottom 20 of tubular body 12 allowing gas to flow through gas permeable solids barrier 32 while preventing loss of scavenger media 30 from bottom 20 of tubular body 12. Gas permeable solids barrier 32 may be positioned across top 22 of tubular body 12 to prevent loss of scavenger media 30 when tubular body 12 is in a horizontal orientation or in a case where high gas pressures could cause scavenger media 30 to be pushed out top 22 of tubular body 12. Referring to FIG. 5, a removable transport closure 34 is positioned across top 22 to prevent loss of scavenger media 30 during transport. It will be understood that either gas permeable solids barrier 32 or removable transport closure 34 or a combination of both may be used to prevent loss of scavenger media 30 during transport or when tubular body 12 is in a horizontal orientation.

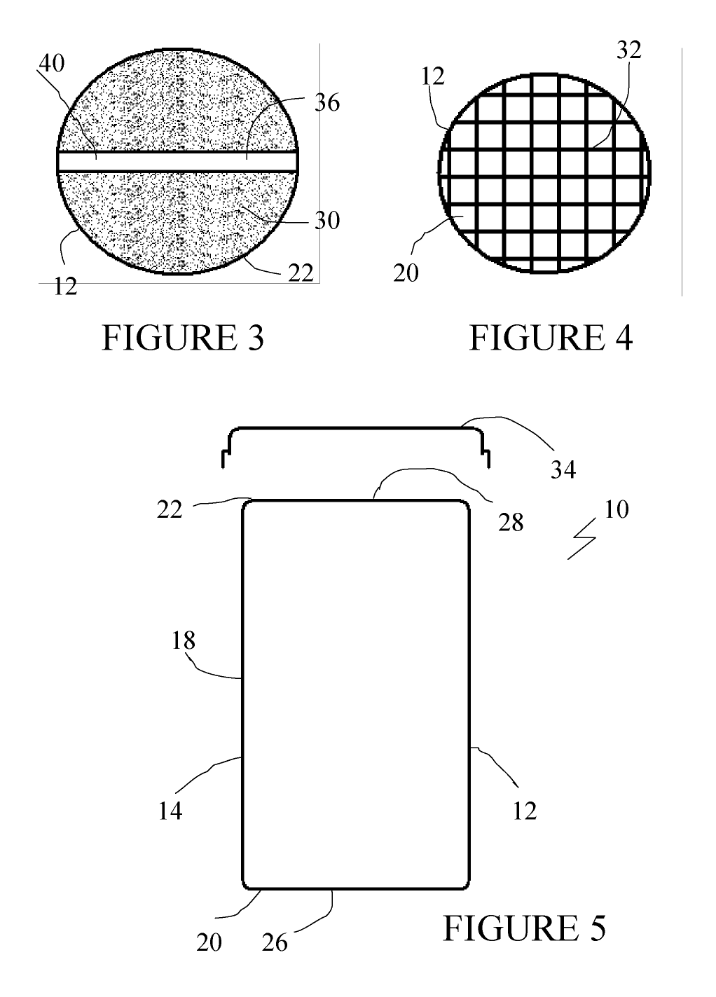

Referring to FIG. 3, tubular body 12 has lifting attachments 36 to facilitate lifting of tubular body 12 by mechanized lifting equipment. Lifting attachment 36 may be a lifting eye 38, shown in FIG. 1 and FIG. 2, a lifting bar 40 or any other suitable lifting attachment. Tubular body 12 may also have hand grips 42 to facilitate manual lifting of canister 10.

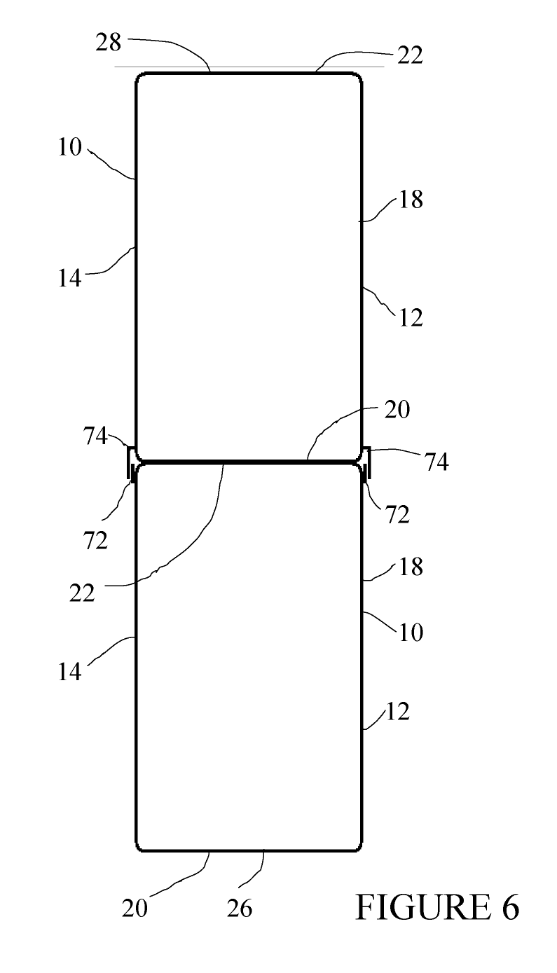

Referring to FIG. 6, top 22 of tubular body 12 has a first engagement 72 which engages a second engagement 74 at the bottom 20 of a like tubular body 12 such that more than one tubular body 12 may be stacked to increase the distance that the gas must travel through scavenger media 30.

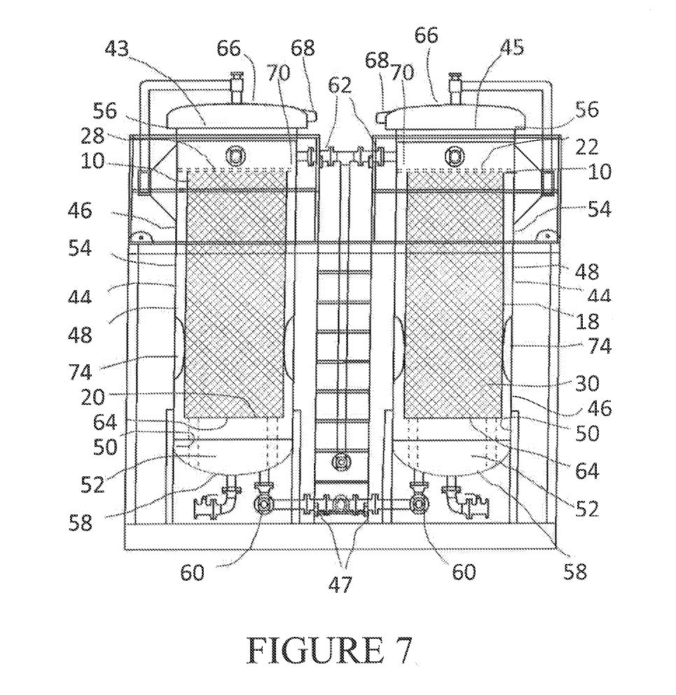

Referring to FIG. 7, particulate scavenger medium canister 10 works in combination with a gas scrubbing unit 44. Gas scrubbing unit 44 includes a vessel 46 that has a defining sidewall 48 with an interior surface 50 defining an interior cavity 52 and an exterior surface 54, a top 56 and a bottom 58. A gas inlet 60 is positioned on or near bottom 58 of vessel 46 and a gas outlet 62 is positioned on or near top 56 of vessel 46. A canister seat 64 is positioned within interior cavity 52. Canister seat 64 supports canister 10 without blocking the flow of gas through gas permeable solids barrier 32. Centralizers 74 may be used to maintain the position of canister 10 in gas scrubbing unit 44, however it will be understood that centralizers 74 are not a necessity. A canister insertion and removal opening 66 is closed by a closure 68. An annular seal 70 is positioned between interior surface 50 of vessel 46 and exterior surface 18 of tubular body 12 when tubular body 12 is positioned on canister seat 64. Annular seal 70 prevents gas from migrating between interior surface 50 of the vessel 46 and exterior surface 18 of tubular body 12 so that the only path to gas outlet 62 of vessel 46 is through internal flow passage 24 of tubular body 12 of particular scavenger medium canister 10 where the gas will react with scavenger media 30.

### Operation:

Referring to FIG. 7, canister insertion and removal opening 66 is opened to allow particulate scavenger medium canister 10 to be placed in gas scrubbing unit 44. Canister insertion and removal opening 66 is reclosed by closure 68 to seal gas scrubbing unit 44. Canister 10 is placed in gas scrubbing unit 44 such that bottom 20 rests on canister seat 64. Annular seal 70 seals the space between interior surface 50 of vessel 46 and exterior surface 18 of canister 10 to prevent gas from bypassing scavenger media 30 contained in canister 10. Top 22 of canister 10 may be covered with a gas permeable solids barrier 32, shown in FIG. 4, or left uncovered while vertically orientated in scrubbing unit 44.

Gas flows through gas inlet 60 which is positioned near bottom 58 of vessel 46. Gas is forced through canister 10 by annular seal 70 which prevents gas flow between canister 10 and interior surface 50 of gas scrubbing unit 44. Referring to FIG. 2, gas travels through gas permeable solids barrier 32 and into gas inlet 26 into internal flow passage 24. Scavenger media 30 absorbs H₂S gas as gas migrates through canister 10. Referring to FIG. 7, gas is released from canister 10 through gas outlet 28 into interior cavity 52 of vessel 46. Gas may be removed from gas scrubbing unit 44 through gas outlet 62 positioned near top 56 of vessel 46. The gas released from vessel 46 is sweet gas. In this embodiment, two gas scrubbing units 44 are used. Gas flows through a first gas scrubbing unit 43 until scavenger media 30 reaches threshold absorption. A valve 47 is switched to change the direction of gas flow from first gas scrubbing unit 43 to a second gas scrubbing unit 45. First gas scrubbing unit 43 can then be depressurized and canister 10 may be removed and a new canister 10 inserted.

Canister 10 is removed from gas scrubbing unit 44 by opening canister insertion and removal opening 66 and pulling canister 10 out. Referring to FIG. 3, a lifting attachment 36 may be attached to mechanized lifting equipment or, referring to FIG. 1, canister 10 may be manually lifted using hand grips 42.

Referring to FIG. 6, multiple canisters 10 may be stacked one on top of the other to increase H₂S gas removal by increasing the distance gas must travel through scavenger media 30. Canisters 10 are held together by a first engagement 72 located on top 22 of tubular body 12 which engages a second engagement 74 at bottom 20 of a like tubular body 12.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A particulate scavenger medium canister, comprising:
a tubular body having a defining peripheral sidewall with an interior surface defining an internal flow passage and an exterior surface, a bottom, and a top, the flow passage having a gas inlet and a gas outlet;
scavenger medium in the form of a plurality of loose discrete particles positioned in the flow passage, such that gas entering the gas inlet must flow through the scavenger medium in order to reach the gas outlet; and
a gas permeable solids barrier positioned across the bottom of the tubular body permitting flow of gas through the gas permeable solids barrier while preventing the loss of the discrete particles of the scavenger medium from the bottom of the tubular body.

2. The particulate scavenger medium canister of claim 1, wherein a gas permeable solids barrier is positioned across the top of the tubular body to prevent loss of the discrete particles of the scavenger medium.

3. The particulate scavenger medium canister of claim 1, wherein a removable transport closure is positioned across the top to prevent loss of the discrete particles of the scavenger medium during transport.

4. The particulate scavenger medium canister of claim 1, wherein the tubular body has lifting attachments to facilitate lifting of the tubular body by mechanized lifting equipment.

5. The particulate scavenger medium canister of claim 1, wherein the tubular body has hand grips to facilitate manual lifting of the canister.

6. The particulate scavenger medium canister of claim 1, in combination with a gas scrubbing unit comprising:
a vessel having a defining sidewall with an interior surface defining an interior cavity and an exterior surface, a top and a bottom, a gas inlet positioned on or near the bottom of the vessel, a gas outlet positioned on or near the top of the vessel, a canister seat positioned within the interior cavity and a canister insertion and removal opening closed by a closure; and
an annular seal between the interior surface of the vessel and the exterior surface of the tubular body when the tubular body is positioned on the canister seat to prevent gas from migrating between the interior surface of the vessel and the exterior surface of the tubular body so that the only path to the gas outlet of the vessel is through the internal flow passage of the tubular body of the particular scavenger medium canister where the gas will react with the particulate scavenger medium.

7. The particulate scavenger medium canister of claim 1, wherein the top of the tubular body has a first engagement which engages a second engagement at the bottom of a like tubular body such that more than one tubular body can be stacked to increase the distance that the gas must travel through the particulate scavenger medium.
